(19) United States
(12) Patent Application Publication
(10) Pub. No.: US 2026/0099264 A1
(43) Pub. Date: Apr. 9, 2026

(54) DISTRIBUTED AND COLLABORATIVE DATA PROCESSING AMONG COMPUTER DEVICES

(71) Applicant: SK Hynix NAND Product Solutions Corp. (dba Solidigm), Rancho Cordova, CA (US)

(72) Inventors: Caleb MCMILLAN, Forest Grove, OR (US); Rita H. WOUHAYBI, Portland, OR (US)

(21) Appl. No.: 18/909,816

(22) Filed: Oct. 8, 2024

(51) Int. Cl. G06F 3/06

(52) U.S. Cl. CPC G06F 3/064; G06F 3/0604; G06F 3/0679

(57) ABSTRACT

A method is implemented at a computer system having one or more processors and memory. The computer system obtains a first data block and generates a set of first features of the first data block. The computer system obtains a second data block, independently of obtaining the first data block, and generates a set of second features of the second data block. The computer system further associates the first data block with the second data block, e.g., determines that both the first data block and the second data block belong to a file. In accordance with an association of the first data block with the second data block, one or more third features of the file are generated based on the set of first features and the set of second features.

### TECHNICAL FIELD

This application relates generally to data management technology, and more particularly to methods, systems, devices, and non-transitory computer-readable storage media for managing data that are collected separately by edge devices in a cloud-based computer system.

### BACKGROUND

Large amounts of data are collected at edge devices and need to be processed efficiently, particularly in applications where the data are applied to generate feedback and controls in real time. Individual edge devices may process data batches with or without the help of a centralized cloud-based server, presenting significant challenges due to inherent limitations of the individual edge devices in terms of power, processing capability, and input/output (I/O) bandwidth. For example, edge devices are frequently constrained by low computational power and the need for energy efficiency, making it difficult to perform complex data analyses. Analysis conducted locally on these devices tends to be relatively simple, limiting the depth and accuracy of insights that can be derived in real-time.

Furthermore, the restricted I/O bandwidth of edge devices constrains the volume of data that can be transmitted to other systems or the cloud for more comprehensive processing, leading to potential bottlenecks in data flow. These resource constraints hinder the ability to perform sophisticated real-time data analysis and decision-making. Additionally, trade-off between computational efficiency and power consumption further limits execution of advanced algorithms or machine learning models on edge devices, necessitating offloading of more complex tasks to centralized or cloud-based systems, which introduces latency and dependency on network availability.

### SUMMARY

Accordingly, there is a need to create a machine learning based data processing solution that leverages computational resources of both distributed edge devices (e.g., a mobile device, a storage device, a sensor device) and a centralized server system and enables complex data analysis with speed, efficiency, depth, and accuracy. Various embodiments of this application are directed to methods, systems, devices, non-transitory computer-readable media for managing data blocks collected from distributed edge devices based on representations (e.g., feature vectors) of these data blocks. Individual data blocks may be converted to the representations having a smaller data size, and exchanged among the distributed edge devices and a server system with reduced usage of communication bandwidth. Analytics techniques and artificial intelligence (AI) models may be applied to process the individual data blocks spread across the individual edge devices in a distributed manner. Data collected by the distributed edge devices do not need to be consolidated at a cloud-based location in their original data formats, thereby reducing associated network traffic and enhancing processing efficiency at the server system.

In an example, the edge devices include storage drives (e.g., solid-state drives (SSDs)) that are arranged in a redundant array of independent disks (RAID) scheme. One of the storage drives may obtain a data chunk that is one of a user data block (also called a data stripe) and an integrity data block. The user data block corresponds to a file including additional data blocks that are stored in other storage drives. In accordance with a determination that the local data chunk is a user data block, the storage drive may process the user data block locally, and communicate with the other storage drives to search for the additional data blocks of the file for further analysis of the file. In some embodiments, the additional data blocks may be identified based on features of the user data block or additional data blocks. In some embodiments, the additional data blocks may be identified based on metadata of the file, e.g., stored in a file system directory of the storage devices.

In some embodiments, edge devices are physical hardware that serve as gateways between the real world and a network communicatively coupled to a centralized cloud or data center. For example, an edge device may be one of a client device, a smart device (e.g., a sensor device, an actuator device), and a storage device.

In one aspect, a method for managing data is implemented at a computer system having one or more processors and memory. The method includes obtaining a first data block and generating a set of first features of the first data block (e.g., at a first electronic device). The method further includes obtaining a second data block, independently of obtaining the first data block, and generating a set of second features of the second data block (e.g., at a second electronic device). The method further includes associating the first data block with the second data block by determining that both the first data block and the second block belong the file. The method further includes, in accordance with an association of the first data block with the second data block, generating one or more third features based on the set of first features and the set of second features.

In some embodiments, the computer system includes a first electronic device. The method further includes determining, by the first electronic device, the first data block and the second data block are available independently of each other. In accordance with a determination that the first data block is available, the set of first features are determined from the first data block, independently of an availability of the second data block and the set of second features at the first electronic device. In accordance with a determination that the second data block is available, the set of second features are determined from the second data block, independently of an availability of the first data block and the set of first features at the first electronic device.

In some embodiments, the computer system includes a first electronic device and a second electronic device. The method further includes determining, by the first electronic device, the first data block is available. In accordance with a determination that the first data block is available, the set of first features are determined from the first data block, independently of an availability of the second data block and the set of second features at the second electronic device. The method further includes determining, by the second electronic device, the second data block is available. In accordance with a determination that the second data block is available, the set of second features are determined from the second data block, independently of an availability of the first data block and the set of first features at the first electronic device.

In some embodiments, the computer system includes a first memory device and a second memory device, and each of the first memory device and the second memory device has a respective data processor for extracting respective features from a respective data block stored on the respective memory device locally. The first data block is stored and the set of first features are extracted in the first memory device, and the second data block is stored and the set of second features are extracted in the second memory device.

In another aspect, some implementations include a computer system that includes one or more processors and memory having instructions stored thereon for performing any of the above methods of processing data.

In yet another aspect, some implementations include a non-transitory computer readable storage medium storing one or more programs. The one or more programs include instructions, which when executed by one or more processors of a computer system cause the one or more processors to implement any of the above methods of processing data.

In some embodiments, processing units of a memory device is configured to create a data processor for processing data locally in addition to a memory controller dedicated to storage-associated data management. Machine learning involves large amounts of data, which require data pre-processing and offline computation. In some embodiments, the data processor created on the memory device is applied to pre-process data that are stored on the memory device for further processing in machine learning. Further, in some embodiments, the memory device includes a bank of drives running RAID for storing the data with redundancy. In some situations, a memory drive does not see a complete file that is an image or any other modality. For example, a first memory drive stores a partial file (e.g., a data block of an associated file) or hosts an integrity data block that is not associated with the partial file, while a second distinct memory drive stores an integrity data block associated with the partial files.

Further, in some embodiments, a single memory drive does not contain all user data and integrity data of a file in. Based on a RAID configuration, a first memory device includes a partial file (e.g., a data stripe) or an integrity data block that may or may not be associated with the partial file. The integrity data block associated with the partial file may be stored in a distinct memory drive. In some embodiments, a processor unit associated with the first memory drive communicates with a RAID controller on a host, and determines whether its data is the partial file or the integrity data block unless it, thereby creating communications between the host and the memory device. Additionally, in some embodiments, the file is stored in a plurality of memory drives including the first memory drive storing the partial file, making it difficult to run analytics (such as object detection, scene detection, anomaly detection, or even defect detection) on the file as a whole. In various embodiments of this application, different data blocks of a file are separately processed to generate respective representations (e.g., feature vectors), and the representations are communicated among the memory drives and the host to facilitate further processing.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 depicts a representative smart work environment, in accordance with some implementations.

FIG. 2 is an example operating environment in which a smart device interacts with a client device or a server system, in accordance with some implementations.

FIG. 3 is a block diagram illustrating a computer system of a smart work environment, in accordance with some implementations.

FIG. 4 is a block diagram of a machine learning system for training and applying data processing models using machine learning, in accordance with some embodiments.

FIG. 5A is a structural diagram of an example neural network applied to process work data in a data processing model, in accordance with some embodiments.

FIG. 5B is an example node in the neural network, in accordance with some embodiments.

FIG. 6 is a block diagram of a memory system of an example electronic device having one or more memory access queues, in accordance with some embodiments.

FIG. 7 is a diagram illustrating an example process of managing data and four example system implementation schemes, in accordance with some embodiments.

FIG. 8 is a flow diagram of an example process for processing a file chunk at a memory device (e.g., SSD), in accordance with some embodiments.

FIG. 9 is a flow diagram of a process of processing an image at least partially in a memory system in a distributed manner, in accordance with some embodiments.

FIG. 10A depicts an example smart work environment associated with a vehicle assembly line, in accordance with some implementations.

FIG. 10B depicts an example smart work environment associated with an electronics manufacturing facility, in accordance with some implementations.

FIG. 11 is a flow diagram of an example data management method, in accordance with some embodiments.

Like reference numerals refer to corresponding parts throughout the several views of the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Various embodiments of this application are directed to methods, systems, devices, non-transitory computer-readable media for managing data blocks collected from distributed edge devices based on representations (e.g., feature vectors) of these data blocks. Individual data blocks may be converted to the representations having a smaller data size, independently of one another (e.g., without waiting for related data blocks to be available). The representations are exchanged among the distributed edge devices (e.g., smart devices, client devices) and a server system with reduced usage of communication bandwidth.

Analytics techniques and models may be applied to process the individual data blocks spread across the individual edge devices in a distributed manner. Data collected by the distributed edge devices do not need to be consolidated at a cloud-based location in their original data formats, thereby reducing associated network traffic and enhancing processing efficiency at the server system.

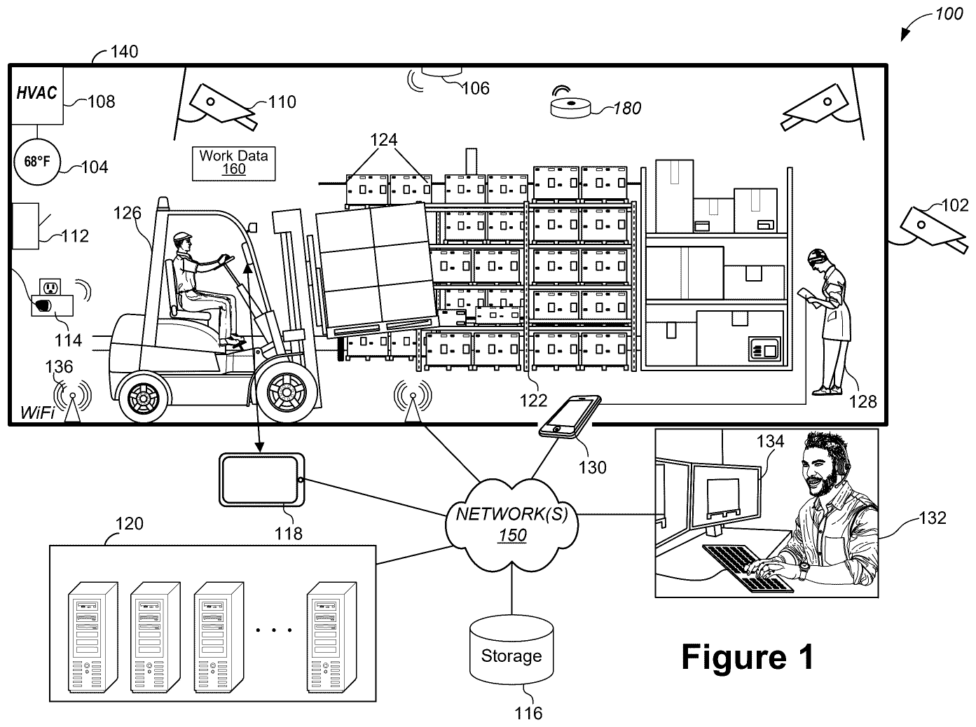

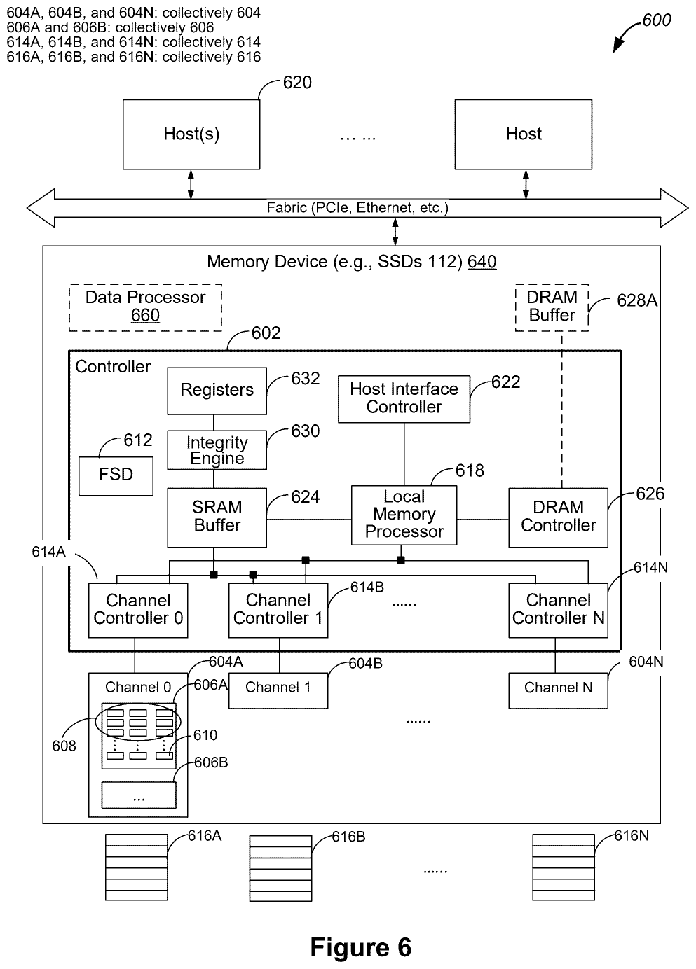

FIG. 1-5B provide background exemplary sensor device networks and capabilities (e.g., machine learning based data processing capabilities) described herein, which are helpful in understanding the details of the embodiments described from FIG. 6 onward.

FIG. 1 depicts a representative smart work environment 100 in accordance with some implementations. The smart work environment 100 includes a structure 140, which may be used as a warehouse, factory, construction site, farm, laboratory, office space, retail store, hospital, and the like. For example, the structure 140 may be used as a distribution center, an e-commerce fulfillment center, an automobile assembly plant, an electronics manufacturing facility, a supermarket, or a retailer store. It will be appreciated that the structure 140 has an open floor plan, high ceilings, and support structures (e.g. columns or beams) and may include different functional areas designed for efficiency, safety, and scalability. Further, the smart work environment 100 may control and/or be coupled to devices outside of the actual structure 140. Indeed, several devices in the smart work environment 100 need not be physically within the structure 140. For example, a surveillance camera 102 may be located outside of the structure 140.

The depicted structure 140 may include a plurality of areas (e.g., storage areas, work areas) that may not be physically separated by walls. The depicted structure 140 may also include rooms (not shown) that are separated from the plurality of areas by walls.

Devices may be mounted on, integrated with, and/or supported by a wall, a floor, a ceiling, or a support structure of the structure 140. Alternatively, devices may be mounted on, integrated with, and/or supported by an object (e.g., a shelf 122, a forklift 126) fixed or moveable in the structure 140.

In some implementations, the smart work environment 100 includes a plurality of devices, including intelligent, multi-sensing, network-connected devices, that integrate seamlessly with each other in a network 150 and/or with a central server system 120 or a cloud-computing system to provide a variety of useful smart work functions. The smart work environment 100 may include one or more surveillance cameras 102, one or more intelligent, multi-sensing, network-connected thermostats 104 (“smart thermostats”) and one or more intelligent, network-connected, multi-sensing hazard detection units 106 (“smart hazard detectors”). In some implementations, the smart thermostat 104 detects ambient climate characteristics (e.g., temperature and/or humidity) and controls an HVAC system 108 accordingly. The smart hazard detector 106 may detect the presence of a hazardous substance or a substance indicative of a hazardous substance (e.g., smoke, fire, and/or carbon monoxide). The surveillance cameras 102 may detect a person's or a vehicle's approach to or departure from the structure 140, identify and/or report any abnormal incidents, and/or control settings on a security system (e.g., to activate or deactivate the security system).

In some implementations, the smart work environment 100 includes one or more intelligent, multi-sensing, network-connected wall switches 112 (“smart wall switches”), along with one or more intelligent, multi-sensing, network-connected wall plug interfaces 114 (“smart wall plugs”). The smart wall switches 112 may detect ambient lighting conditions, detect room-occupancy states, and control a power and/or dim state of one or more lights. In some instances, smart wall switches 112 may also control a power state or speed of a fan, such as a ceiling fan. The smart wall plugs 114 may detect occupancy of a room or enclosure and control supply of power to one or more wall plugs (e.g., such that power is not supplied to the plug if nobody is present in the structure 140).

In some implementations, the smart work environment 100 includes a plurality of network-connected cameras 110 that are configured to provide video monitoring and security inside the structure 140. For example, the structure 140 is used as a warehouse, which is a bustling hub of activity, with neatly organized shelves 122 stretching high to accommodate an extensive inventory of product boxes 124. Each shelf 122 is carefully labeled and arranged to maximize space and ensure efficient access to goods. A forklift 126 may navigate the wide aisles with precision, lifting and moving boxes 124 from one location to another with a steady hum of its engine. The forklift 126 may include a computer device 118 for obtaining and updating information of the boxes 124 (e.g., box locations, weights, handling details). A worker 128 may check the stock levels on a handheld device 130, verifying the quantities and ensuring that inventory records match the physical stock. The air is filled with the sounds of the forklift's beeping and the occasional rustle of boxes as the warehouse maintains a routine of receiving, storing, and preparing products for distribution. A plurality of cameras 110 are distributed at different locations in the structure 140, and configured to capture static images or video clips monitoring activities of the forklift 126 and the worker 128.

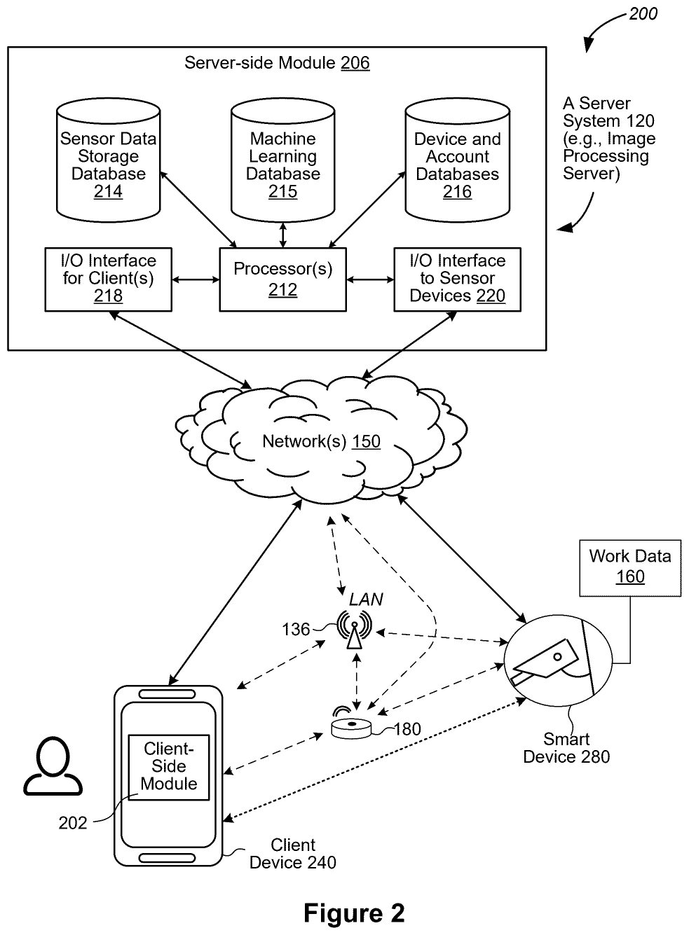

The devices 102-114 (e.g., collectively called smart devices 280 in FIG. 2) are examples of sensors and actuators that are disposed in the smart work environment 100 for collecting work data 160 (e.g., image data captured by cameras 110, temperature data captured by the smart thermostat 104). In some embodiments now shown, a variety of smart devices 280 are used to optimize efficiency and ensure smooth operations in the smart work environment 100. For example, radio frequency identification (RFID) sensors are employed to track products throughout the structure 140, ensuring that items are accurately located and inventoried. Proximity sensors may help robots and autonomous vehicles navigate safely by detecting obstacles and other machines. Infrared and optical sensors are used for barcode scanning, enabling quick identification of products. Additionally, pressure and weight sensors ensure that items are handled carefully and that shipping weights are accurate. Additional environmental sensors monitor conditions such as humidity to protect sensitive products. These technologies work together to create a highly automated and efficient smart work environment 100.

By virtue of network connectivity, one or more of the smart devices 280 may further allow a user to interact with the devices even if a user 132 is not proximate to the devices For example, the user 132 may communicate with a device using a computer device 134 (e.g., a desktop computer, laptop computer, a tablet computer, or other portable electronic device (e.g., a smartphone)). A webpage or application may be configured to receive communications from the user 132 and control the smart devices 280 based on the communications and/or to present information about the device's operation to the user 132. For example, the user 132 may view a current set point temperature for the smart thermostat 104 and adjust it using the computer device 134. The user 132 may review signature events captured by the camera 110 or adjust settings of the camera 110 using the computer device 134. The user 132 may be physically located within or outside the structure 140 during this remote communication.

As discussed above, users may control the smart thermostat 104 and other smart devices in the smart work environment 100 using a network-connected computer device 134. In some examples, a plurality of employees of a business entity associated with the structure 140 may register their devices 134 with the smart work environment 100. Such registration may be made at a central server 120 to authenticate the employees and/or the devices 134 as being associated with the structure 140 and to give permission to the employees to use the devices 134 to access the smart devices 280 in the structure 140. Employees may use their registered devices 134 to remotely control the smart devices 280 of the structure 140, e.g., when an employee is at work, on vacation, or at a separate office location. The employee may also use a registered device 134 (e.g., handheld device 130) to control the smart devices 280 when the employee is actually located inside the structure 140, such as when the employee is checking stocking in the warehouse.

In some implementations, in addition to containing processing and sensing capabilities, the devices 102, 104, 106, 108, 110, 112, and/or 114 (“the smart devices”) are capable of data communications and information sharing with other smart devices, a central server or cloud-computing system, and/or other devices that are network-connected. The required data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any of a variety of custom or standard wired protocols (e.g., CAT6 Ethernet or HomePlug), or any other suitable communication protocol.

In some implementations, the smart devices 280 serve as wireless or wired repeaters. For example, a first one of the smart devices communicates with a second one of the smart devices via a wireless router. The smart devices may further communicate with each other via a connection to one or more networks 150 such as the Internet. Through the one or more networks 150, the smart devices may communicate with a smart work server system 120 (also called a central server system and/or a cloud-computing system herein). In some implementations, the smart work server system 120 may include multiple server systems, each dedicated to data processing associated with a respective subset of the smart devices (e.g., a video server system may be dedicated to data processing associated with camera(s) 110). The smart work server system 120 may be associated with a manufacturer, support entity, or service provider associated with the smart devices 280. In some implementations, the smart work environment 100 relies on a dedicated hub device 180 to manage smart devices 280 located within the smart work environment 100, and a hub device server system associated with the hub device 180 serves as the server system 120.

In some implementations, a user is able to contact customer support using a smart device itself rather than needing to use other communication means, such as a telephone or Internet-connected computer. In some implementations, software updates are automatically sent from the smart work server system 120 to smart devices 280 (e.g., when available, when purchased, or at routine intervals). In some embodiments, the smart work environment 100 further includes a storage 116 for storing data related to the servers 120, smart devices 280, client devices 118, 130, and 134 (e.g., collectively called client device 240 in FIG. 2), and applications executed on the client devices. In some embodiments, the storage 116 includes a plurality of SSDs.

FIG. 2 is an example operating environment 100 in which a smart device 280 (e.g., cameras 110) interacts with a client device 240 (e.g., devices 118, 130, and 134 in FIG. 1) or a server system 120 (e.g., an image processing server), in accordance with some implementations. In the operating environment 200, the server system 120 provides data processing for monitoring and facilitating review of object location/motion associated with imaging device data streams (e.g., raw or processed work data 160) captured by multiple cameras 110 disposed in the structure 140. As shown in FIG. 2, the server system 120 may receive raw or processed work data 160 from smart devices 280 (standalone or integrated) located at various physical locations in the smart work environments 100. Each smart device 280 may be bound to one or more reviewer accounts, and the server system 120 may further process the received work data 160 to obtain information associated with the smart device 280 and the corresponding reviewer accounts. For a camera 110, the obtained information could be object locations, object movements, user gestures, and depth mapping. In some implementations, the server system 120 provides the information to client devices 240 associated with the reviewer accounts. In some implementations, the server system 120 uses the information to control a smart device 280 linked to the reviewer accounts.

In some implementations, the server system 120 is a dedicated image processing server that provides data processing services to cameras 110 and client devices 240 independently of other services provided by the server system 120.

In some implementations, each of the smart devices 280 captures work data 160 using signal detectors and sends the captured work data 160 to the server system 120 substantially in real time. In some implementations, each of the smart devices 280 includes a controller device (e.g., a smart device in which a camera 110 is integrated) that serves as an intermediary between the smart device 280 and the server system 120. The controller device receives the work data 160 from the one or more smart devices 280, optionally performs some preliminary processing on the work data 160, and sends the processed work data 160 to the server system 120 on behalf of the one or more smart devices 280 substantially in real time. In some implementations, each smart device 280 has its own on-board processing capabilities to perform some preliminary processing on the captured work data 160 before sending the processed work data 160 (along with metadata obtained through the preliminary processing) to the controller device and/or the server system 120. In some implementations, the client device 240 located in the smart work environment 100 functions as the controller device to at least partially process the captured work data 160.

In accordance with some implementations, each of the client devices 240 includes a client-side module 202. The client-side module 202 communicates with a server-side module 206 executed on the server system 120 through the one or more networks 150. The client-side module 202 provides client-side functionality for information monitoring, review processing, and communication with the server-side module 206. The server-side module 206 provides server-side functionality for event monitoring and review processing for any number of client-side modules 202, each residing on a respective client device 240. The server-side module 206 also provides server-side functionality for response processing and device control for any number of the smart devices 280.

In some implementations, the server-side module 206 includes one or more processors 212, a sensor data database 214, machine learning database 215, device and account databases 216, an I/O interface 218 to one or more client devices, and an I/O interface 220 to one or more smart devices 280. The I/O interface 218 to one or more clients facilitates the client-facing input and output processing for the server-side module 206. The device and account databases 216 store a plurality of profiles for reviewer accounts registered with the server system 120. A user profile includes account credentials for each reviewer account, and identifies one or more smart devices 280 linked to the reviewer account. In some implementations, the user profile of each reviewer account includes information related to capabilities, device characteristics, and lookup tables for the smart devices 280 linked to the reviewer account. The I/O interface 220 to one or more imaging devices facilitates communications with one or more smart devices 280 (standalone or integrated). The sensor data storage database 214 stores raw or processed work data 160 received from the smart devices 280 and associated information, as well as various types of metadata, such as device characteristics of signal emitters and detectors, lookup tables, modulation signals, and sampling rates. In some implementations, this data is used for generating additional information associated with each reviewer account. The machine learning database 215 stores data used by the server 120, the smart devices 280, or the client devices 240 to process the work data 160 collected by the smart devices 280 based on machine learning. For example, machine learning based data processing models and associated training data are stored in the machine learning database 215.

Client devices 240 include handheld computers, wearable computing devices, personal digital assistants (PDAs), tablet computers, laptop computers, desktop computers, cellular telephones, smart phones, enhanced general packet radio service (EGPRS) mobile phones, media players, navigation devices, game consoles, televisions, remote controls, point-of-sale (POS) terminals, vehicle-mounted computers, ebook readers, or a combination of any two or more of these data processing devices or other data processing devices.

Examples of the one or more networks 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 120 is implemented on one or more standalone data processing devices or a distributed network of computers. In some implementations, the server system 120 employs various virtual devices and/or services of third party service providers (e.g., third-party cloud service providers) to provide the underlying computing resources and/or infrastructure resources of the server system 120. In some implementations, the server system 120 includes handheld computers, tablet computers, laptop computers, desktop computers, or a combination of any two or more of these data processing devices or other data processing devices.

The server-client environment 200 shown in FIG. 2 includes both a client-side portion (e.g., the client-side module 202) and a server-side portion (e.g., the server-side module 206). The division of functionality between the client and server portions of operating environment 200 can vary in different implementations. Similarly, the division of functionality between the smart devices 280 and the server system 120 can vary in different implementations. In some implementations, the client-side module 202 is a thin-client that provides only user-facing input and output processing functions, and delegates other data processing functionality to a backend server (e.g., the server system 120). In some implementations, a smart device 280 is a simple data capturing device that continuously captures and streams work data 160 to the server system 120, with limited local preliminary processing of the data. Although many aspects of the present technology are described from the perspective of a computer system (e.g., system 300) as a whole, the corresponding actions performed by the client device 240 and/or the server system 120 would be apparent to those of skill in the art. Some aspects of the present technology may be described from the perspective of the client device or the server system, and the corresponding actions performed by the server system would be apparent to those of skill in the art. Furthermore, some aspects of the present technology may be performed by the server system 120, the client device 240, and the smart device 280 cooperatively.

It should be understood that the operating environment 200 that involves the server system 120, the client device 240, and the smart device 240 is merely an example. Many aspects of operating environment 200 are generally applicable in other operating environments in which a server system provides data processing for monitoring and facilitating review of data captured by other types of electronic devices.

The smart devices, the client devices, and the server system communicate with each other using the one or more communication networks 150. In an example smart work environment 100, two or more devices (e.g., the network interface device 136, the hub device 180, the client devices 240, and the smart devices 204) are located in close proximity to each other, such that they can be communicatively coupled in the same sub-network via wired connections, a WLAN, or a Bluetooth Personal Area Network (PAN). The Bluetooth PAN is optionally established based on classical Bluetooth technology or Bluetooth Low Energy (BLE) technology. In some implementations, each of the hub device 180, the client device 240, and the smart devices 204 are communicatively coupled to the networks 150 via the network interface device 136.

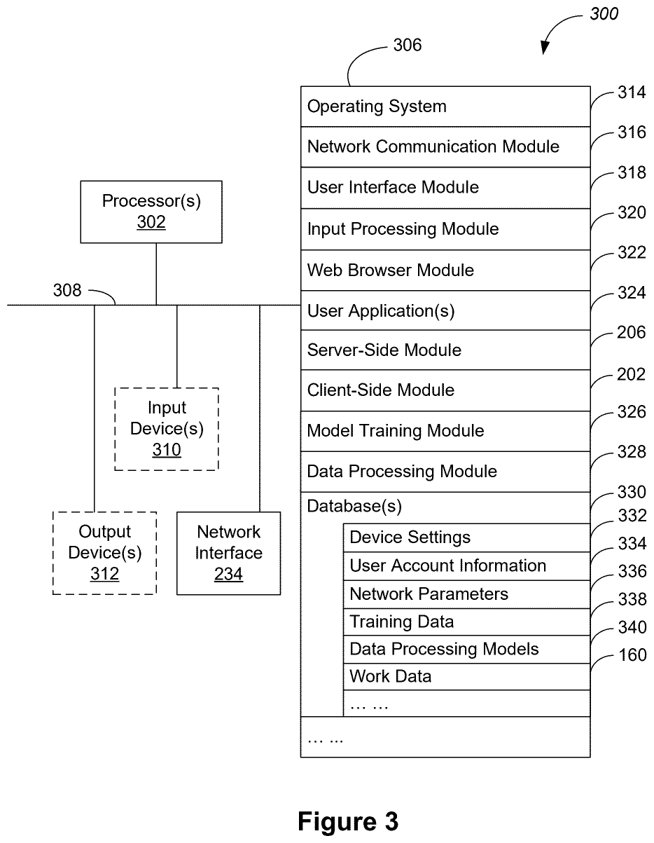

FIG. 3 is a block diagram illustrating a computer system 300 of a smart work environment 100 in accordance with some implementations. The computer system 300 includes a server 120, a client device 240 (e.g., computer device 118, 130, or 134 in FIG. 1), a smart device 280 (e.g., devices 102-114 in FIG. 1), a storage 116, or a combination thereof, and is configured to enable the smart work environment 100. The computer system 300 includes one or more processing units (CPUs) 302, one or more network interfaces 304, memory 306, and one or more communication buses 308 for interconnecting these components (sometimes called a chipset). In some implementations, the computer system 300 includes one or more input devices 310, which facilitate user input, such as a keyboard, a mouse, a voice-command input unit or microphone, a touch screen display, a touch-sensitive input pad, a gesture capturing camera, or other input buttons or controls. In some implementations, the computer system 300 uses a microphone and voice recognition or a camera and gesture recognition to supplement or replace the keyboard. In some implementations, the computer system 300 includes one or more cameras, scanners, or photo sensor units for capturing images. In some implementations, the computer system 300 includes one or more output devices 312, which enable presentation of user interfaces and display content, including one or more speakers and/or one or more visual displays.

The memory 306 includes high-speed random access memory, such as DRAM, SRAM, DDR RAM, or other random access solid state memory devices. In some implementations, the memory 306 includes non-volatile memory, such as one or more magnetic disk storage devices, one or more optical disk storage devices, one or more flash memory devices, or one or more other non-volatile solid state storage devices. In some implementations, the memory 306 includes one or more storage devices remotely located from the processing units 302. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof:
an operating system 314, which includes procedures for handling various basic system services and for performing hardware dependent tasks;
a network communication module 316, which connects the computer system 300 to other devices (e.g., various servers in the server system 120, a client device, or a smart device) via one or more network interfaces 304 (wired or wireless) and one or more networks 150, such as the Internet, other wide area networks, local area networks, metropolitan area networks, and so on;
a user interface module 318, which enables presentation of information (e.g., a graphical user interface for presenting applications, widgets, websites and web pages thereof, and/or games, audio and/or video content) at a client device 118, 130, and 134;
an input processing module 320 for detecting one or more user inputs or interactions from one of the one or more input devices 310 and interpreting the detected input or interaction;
a web browser module 322 for navigating, requesting (e.g., via HTTP), and displaying websites and web pages thereof, including a web interface for logging into a user account associated with a client device 140 or another electronic device, controlling the client or electronic device if associated with the user account, and editing and reviewing settings and data that are associated with the user account;
one or more user applications 324 for execution by the servers 120 (e.g., smart work applications, and/or other web or non-web based applications);
a server-side module 206, which communicates both with smart work environments 100 and with client-side modules 202 and includes a plurality of individual programs, procedures, modules, and/or objects for performing a variety of functions;
a client-side module 202, which communicates with the server-side module 206 in the smart work environment 100 and includes a plurality of individual programs, procedures, modules, and/or objects for performing a variety of functions;
model training module 326 for receiving training data and establishing one or more data processing models 340 for processing work data 160 (e.g., video, image, audio, or textual data) collected by the smart devices 280;
a data processing module 328 for processing work data 160 using data processing models 340, thereby identifying information contained in the work data 160, matching the work data 160 with other data, categorizing the work data 160, or synthesizing related work data 160; and
one or more databases 330 for storing at least data including one or more of:
   device settings 332 including common device settings (e.g., service tier, device model, storage capacity, processing capabilities, communication capabilities, etc.) of the one or more servers 120, client devices, or smart devices;
   user account information 334 for the one or more user applications 324, e.g., user names, security questions, account history data, user preferences, and predefined account settings;
   network parameters 336 for the one or more communication networks 150, e.g., IP address, subnet mask, default gateway, DNS server and host name;
   training data 338 for training one or more data processing models 340;
   data processing model(s) 340 for processing work data 160 (e.g., video, image, audio, or textual data) using deep learning techniques;
   work data 160 and associated results, where the work data 160 is processed using the data processing models 340 remotely at the server 120 or locally at the client device 240 to provide the associated results to be presented on the client devices or further processed.

In some implementations, the server-side module 106 acts as a control layer or API to the underlying functionality. In some implementations, the server-side module includes one or more of an emitter modulation module, a signal detection module, an object detection module, a location module, a movement module, a depth mapping module, and/or a gesture determination module for a smart device 280. Some implementations implement all of these features at a server system 120, some implementations implement all of these features at the camera 110, and some implementations distribute the functionality between the server 120 and the imaging device (e.g., based on efficiency considerations). In some implementations, the server-side module 206 includes a response processing module, which receives either raw unprocessed signals received at a camera 110 or signals that have been preprocessed by a local response processing module at the camera 110. The response processing module prepares the work data 160 (e.g., time of flight detection data) for use by the location module, the movement module, the depth mapping, and/or the gesture determination module. The server-side module 206 also includes an account administration module, which enables users to set up smart work environments 100 and to identify the smart devices 204 associated with the smart work environment 100.

Although many aspects of the present technology are described from the perspective of a computer system as a whole, the corresponding actions performed by the client device 240 and/or the server system 120 would be apparent to those of skill in the art. The server-side module 206 and the client-side module 202 are implemented at the server 120 and the client device 240, respectively. Each of the other modules 314-328 may be implemented in any of a server 120, a client device 240 (e.g., computer device 118, 130, or 134 in FIG. 1), a smart device 280 (e.g., devices 102-114 in FIG. 1), a storage 116, or a combination thereof.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules, or data structures, and thus various subsets of these modules may be combined or otherwise rearranged in various implementations. In some implementations, the memory 306 stores a subset of the modules and data structures identified above. In some implementations, the memory 306 stores additional modules and data structures not described above.

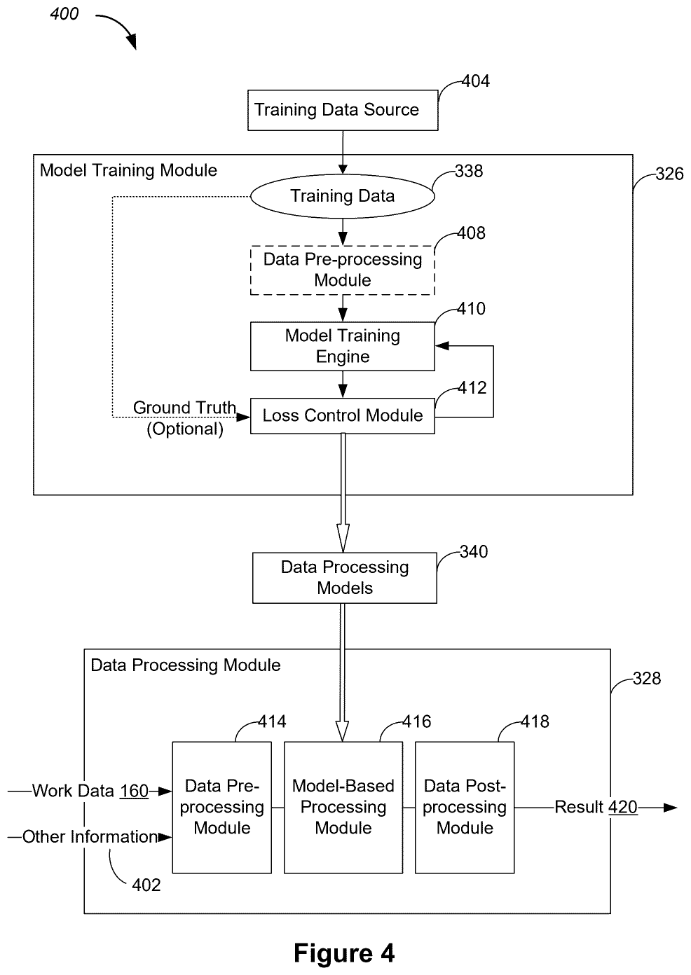

FIG. 4 is a block diagram of a machine learning system 400 for training and applying data processing models 340 using machine learning, in accordance with some embodiments. The machine learning system 400 includes a model training module 326 establishing one or more data processing models 340 and a data processing module 328 for processing data collected by smart devices 280 (e.g., cameras 110) using the data processing model 340. In some embodiments, both the model training module 326 (e.g., the model training module 326 in FIG. 3) and the data processing module 328 are located in the server 120, while a training data source 404 provides training data 338 to the server 120. In some embodiments, the training data source 404 is the data obtained from the smart devices 280, from another server 120, from storage 106, or from a client device. Alternatively, in some embodiments, the model training module 326 (e.g., the model training module 326 in FIG. 3) is located at a server 120, and the data processing module 328 is located in a smart device 280 or a client device 240. The server 120 trains the data processing models 328 and provides the trained models 340 to a smart device 280 or a client device 240 to process real-time work data 160 captured by the smart device 280.

In some embodiments, the training data 338 provided by the training data source 404 include a standard dataset (e.g., a set of work site images) widely used by engineers in an associated industry to train data processing models 340. In some embodiments, the training data 338 includes work data 160 and/or additional work site information, which is collected from one or more smart devices that will apply the data processing models 340 or collected from distinct smart devices that will not apply the data processing models 340. Further, in some embodiments, a subset of the training data 338 is modified to augment the training data 338. The subset of modified training data is used in place of or jointly with the subset of training data 338 to train the data processing models 340.

In some embodiments, the model training module 326 includes a model training engine 410, and a loss control module 412. Each data processing model 340 is trained by the model training engine 410 to process corresponding work data 160.

Specifically, the model training engine 410 receives the training data 338 corresponding to a data processing model 340 to be trained, and processes the training data to build the data processing model 340. In some embodiments, during this process, the loss control module 412 monitors a loss function comparing the output associated with the respective training data item to a ground truth of the respective training data item. In these embodiments, the model training engine 410 modifies the data processing models 340 to reduce the loss, until the loss function satisfies a loss criteria (e.g., a comparison result of the loss function is minimized or reduced below a loss threshold). The data processing models 340 are thereby trained and provided to the data processing module 328 to process work data 160.

In some embodiments, the model training module 326 further includes a data pre-processing module 408 configured to pre-process the training data 338 before the training data 338 is used by the model training engine 410 to train a data processing model 340. For example, an image pre-processing module 408 is configured to format images in the training data 338 into a predefined image format. For example, the preprocessing module 408 may normalize the images to a fixed size, resolution, or contrast level. In another example, an image pre-processing module 408 extracts a region of interest (ROI) corresponding to a target area or object in each image or separates content of the target area or object into a distinct image.

In some embodiments, the model training module 326 uses supervised learning in which the training data 338 is labelled and includes a desired output for each training data item (also called the ground truth in some situations). In some embodiments, the desirable output is labelled manually by people or labelled automatically by the model training model 326 before training. In some embodiments, the model training module 326 uses unsupervised learning in which the training data 338 is not labelled. The model training module 326 is configured to identify previously undetected patterns in the training data 338 without pre-existing labels and with little or no human supervision. Additionally, in some embodiments, the model training module 326 uses partially supervised learning in which the training data is partially labelled.

In some embodiments, the data processing module 328 includes a data pre-processing module 414, a model-based processing module 416, and a data post-processing module 418. The data pre-processing modules 414 pre-processes work data 160 based on the type of the work data 160. In some embodiments, functions of the data pre-processing modules 414 are consistent with those of the pre-processing module 408, and convert the work data 160 into a predefined data format that is suitable for the inputs of the model-based processing module 416. The model-based processing module 416 applies the trained data processing model 340 provided by the model training module 326 to process the pre-processed work data 160. In some embodiments, the model-based processing module 416 also monitors an error indicator to determine whether the work data 160 has been properly processed in the data processing model 340. In some embodiments, the processed work data is further processed by the data post-processing module 418 to create a preferred format or to provide additional work information, associated with the smart work environment 100, which can be derived from the processed work data.

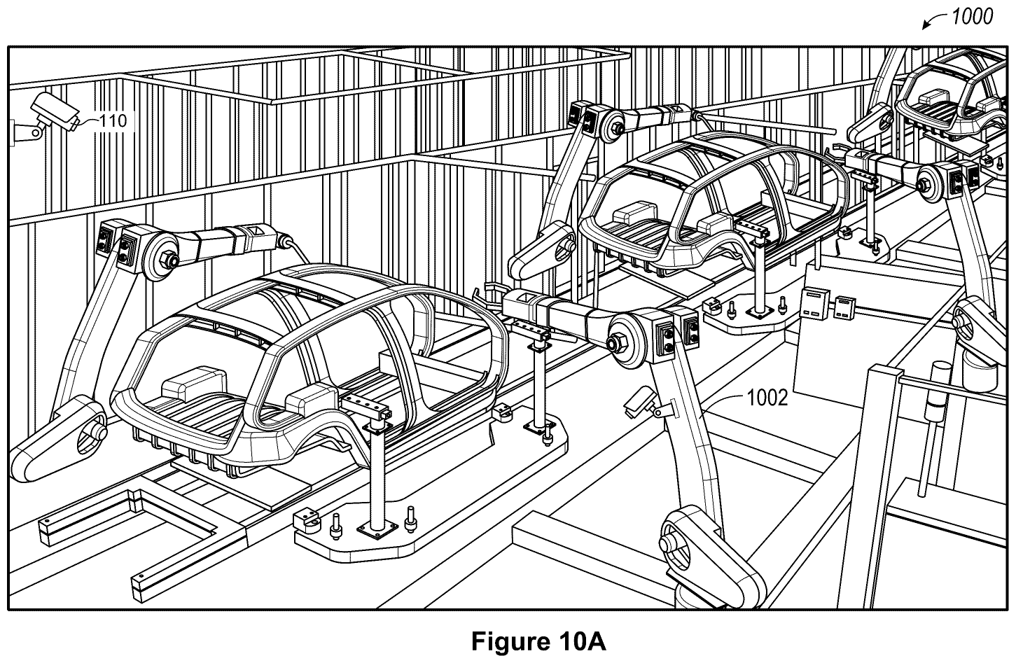

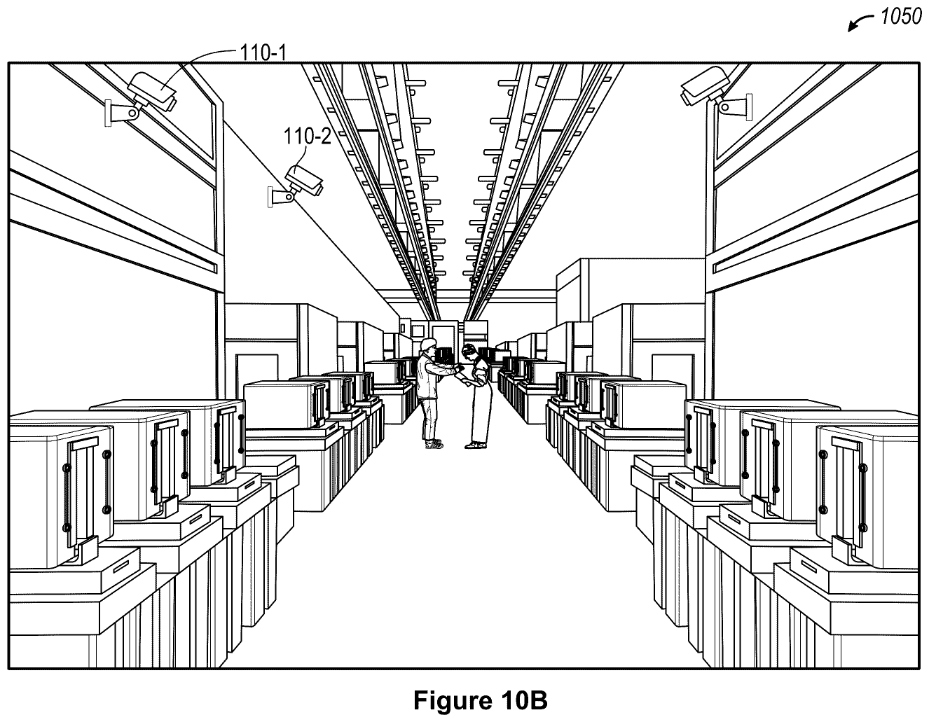

In some embodiments, work data 160 are supplemented with other information 402 (e.g., additional work site information, which is collected from one or more smart devices that will apply the data processing models 340 or collected from distinct smart devices that will not apply the data processing models 340). In some embodiments, the data processing module 328 uses the processed work data (e.g., result 420) to at least partially autonomously control an equipment or tool (e.g., forklift 126 in FIG. 1) that operates in the smart work environment 100. For example, the processed work data includes control instructions that are used by a control system (manned or unmanned) to drive the forklift 126. In some embodiments, the processed work data (e.g., result 420) is applied to at least partially autonomously control a robot operating on a vehicle assembly line (FIG. 10A) or in an electronics manufacturing facility (FIG. 10B).

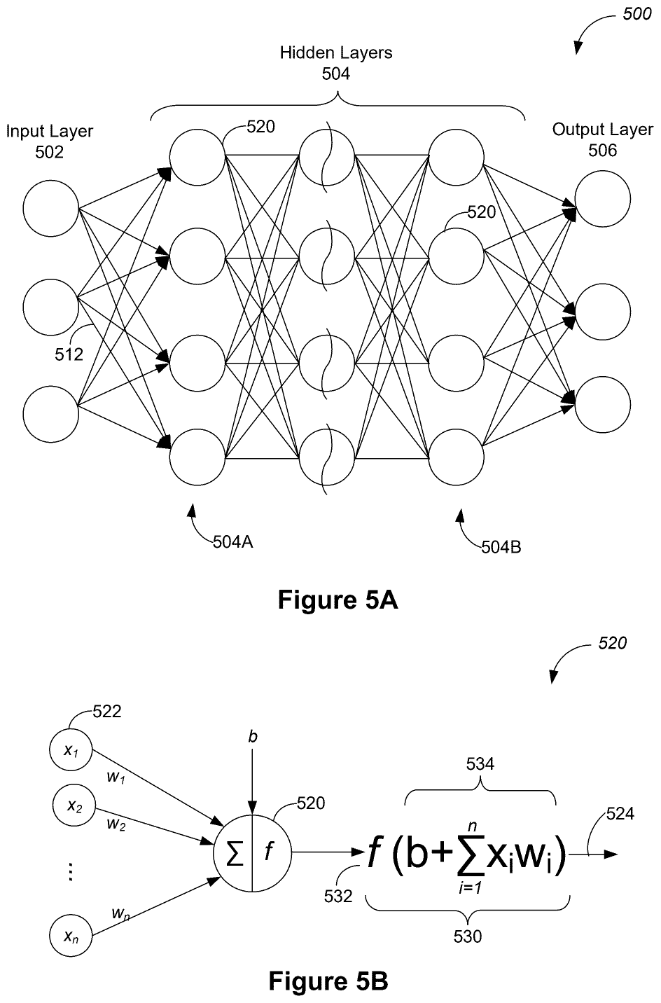

FIG. 5A is a structural diagram of an example neural network 500 applied to process work data in a data processing model 340, in accordance with some embodiments, and FIG. 5B is an example node 520 in the neural network 500, in accordance with some embodiments. It should be noted that this description is used as an example only, and other types or configurations may be used to implement the embodiments described herein. The data processing model 340 is established based on the neural network 500. A corresponding model-based processing module 416 applies the data processing model 340 including the neural network 500 to process work data 160 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w₁, w₂, w₃, and w₄ according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a data processing model 340 to process work data (e.g., video and image data captured by cameras 110). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the data processing model 340 to process work data 160. Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of work data are processed by the data processing module 328, and two or more types of neural networks (e.g., both a CNN and an RNN) are applied in the same data processing model 340 to process the work data jointly.

The training process is a process for calibrating all of the weights wᵢ for each layer of the neural network 500 using training data 338 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the weighted outputs 534 from the previous layer before the activation function 532 is applied. The network bias b provides a perturbation that helps the neural network 500 avoid over fitting the training data. In some embodiments, the result of the training includes a network bias parameter b for each layer.

FIG. 6 is a block diagram of a memory system 600 of an example electronic device having one or more memory access queues 616, in accordance with some embodiments. The memory system 600 is coupled to one or more host devices 620 (e.g., a processor module) and configured to store instructions and data for an extended time, e.g., when the electronic device sleeps, hibernates, or is shut down. The host device 620 is configured to access the instructions and data stored in the memory system 600 and process the instructions and data to run an operating system (OS) and execute user applications. The memory system 600 includes one or more memory devices 640 (e.g., SSD(s)). Each memory device 640 further includes a controller 602 and a plurality of memory channels 604 (e.g., channel 604A, 604B, and 604N). Each memory channel 604 includes a plurality of memory cells. The controller 602 is configured to execute firmware level software to bridge the plurality of memory channels 604 to the host device 620. More specifically, the controller 602 may communicate with the host device 620, manage a file system directory (FSD) 612 for tracking data locations in the memory channels 604, organize the plurality of memory channels 604, and facilitate internal and external requests to access the memory channels 604. In some embodiments, each memory device 640 is formed on a printed circuit board (PCB).

Each memory channel 604 includes on one or more memory packages 606 (e.g., two memory dies). In an example, each memory package 606 (e.g., memory package 606A or 606B) corresponds to a memory die. Each memory package 606 includes a plurality of memory planes 608, and each memory plane 608 further includes a plurality of memory pages 610. Each memory page 610 includes an ordered set of memory cells, and each memory cell is identified by a respective physical address.

Each memory channel 604 is coupled to a respective channel controller 614 (e.g., controller 614A, 614B, or 614N) configured to control internal and external requests to access memory cells in the respective memory channel 604. In some embodiments, each memory package 606 (e.g., each memory die) corresponds to a respective queue 616 (e.g., queue 616A, 616B, or 616N) of memory access requests. In some embodiments, each memory channel 604 corresponds to a respective queue 616 of memory access requests. Further, in some embodiments, each memory channel 604 corresponds to a distinct and different queue 616 of memory access requests. In some embodiments, a subset (less than all) of the plurality of memory channels 604 corresponds to a distinct queue 616 of memory access requests.

In some embodiments, all of the plurality of memory channels 604 of the memory device 640 corresponds to a single queue 616 of memory access requests. Each memory access request is optionally received internally from the memory device 640 to manage the respective memory channel 604 or externally from the host device 620 to write or read data stored in the respective channel 604. Specifically, each memory access request includes one of: a system write request that is received from the memory device 640 to write to the respective memory channel 604, a system read request that is received from the memory device 640 to read from the respective memory channel 604, a host write request that originates from the host device 620 to write to the respective memory channel 604, and a host read request that is received from the host device 620 to read from the respective memory channel 604. It is noted that system read requests (also called background read requests or non-host read requests) and system write requests are dispatched by a memory controller 602 to implement internal memory management functions. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 614, the controller 602 further includes a local memory processor 618, a host interface controller 622, an SRAM buffer 624, and a DRAM controller 626. The local memory processor 618 accesses the plurality of memory channels 604 based on the one or more queues 616 of memory access requests. In some embodiments, the local memory processor 618 writes into and read from the plurality of memory channels 604 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 604 has a size of 16 KB (e.g., one memory page). In another example, each memory block to be written or read jointly in the plurality of memory channels 604 has a size of 64 KB (e.g., four memory pages). In some embodiments, each page has 16 KB user data and 6 KB metadata.

In some embodiments, the local memory processor 618 stores data to be written into, or read from, each memory block in the plurality of memory channels 604 in an SRAM buffer 624 of the controller 602. Alternatively, in some embodiments, the local memory processor 618 stores data to be written into, or read from, each memory block in the plurality of memory channels 604 in a DRAM buffer 628A that is included in memory device 640, e.g., by way of the DRAM controller 626. Alternatively, in some embodiments, the local memory processor 618 stores data to be written into, or read from, each memory block in the plurality of memory channels 604 in a buffer that is main memory used by one or more hosts 620. The local memory processor 618 of the controller 602 accesses the buffer via the host interface controller 622.

In some embodiments, the memory device 640 includes an integrity engine 630 (e.g., an LDPC engine) and registers 632, which include a plurality of registers or SRAM cells or flip-flops and are coupled to the integrity engine 630. The integrity engine 630 is coupled to the memory channels 604 via the channel controllers 614 and SRAM buffer 624.

In some embodiments, the memory device 640 includes a data processor 660 in addition to the memory controller 618, and the data processor 660 provides an internal processing capability to the memory device 640. The memory controller 618 is configured to implement internal memory management functions including, but are not limited to, garbage collection, wear levelling, read disturb mitigation, memory snapshot capturing, memory mirroring, caching, and memory sparing. The data processor 660 is configured to process internal computational workloads (e.g., the data processing operations) locally on the memory device 640. Further, in some embodiments, the memory device 640 includes a plurality of processing units (e.g., processors 302 in FIG. 3), which may be allocated to implement the memory controller 618 and the data processor 660.

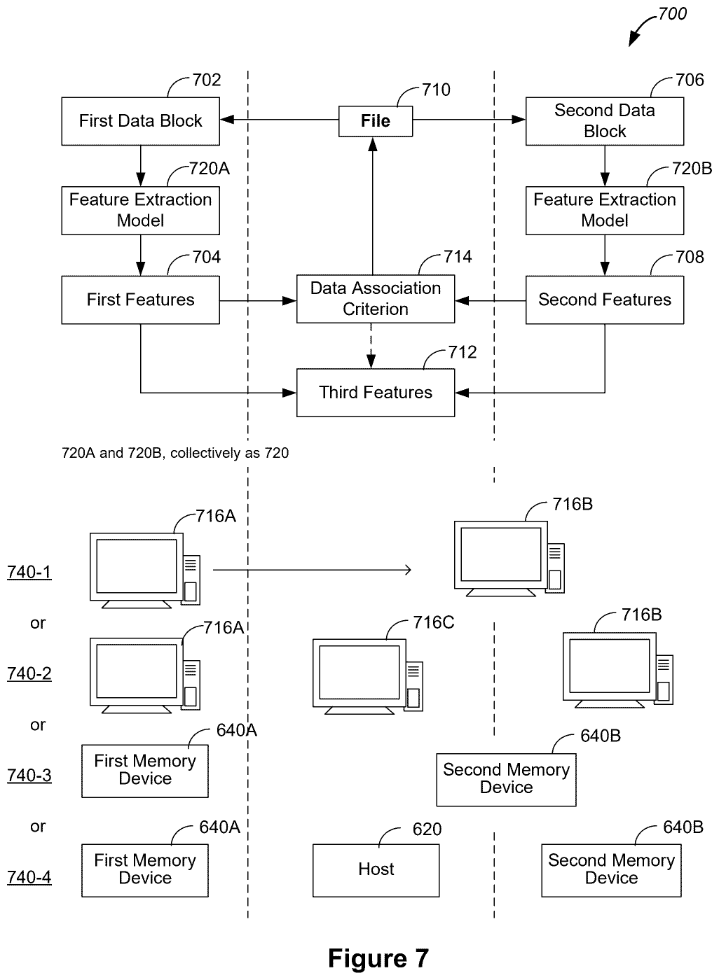

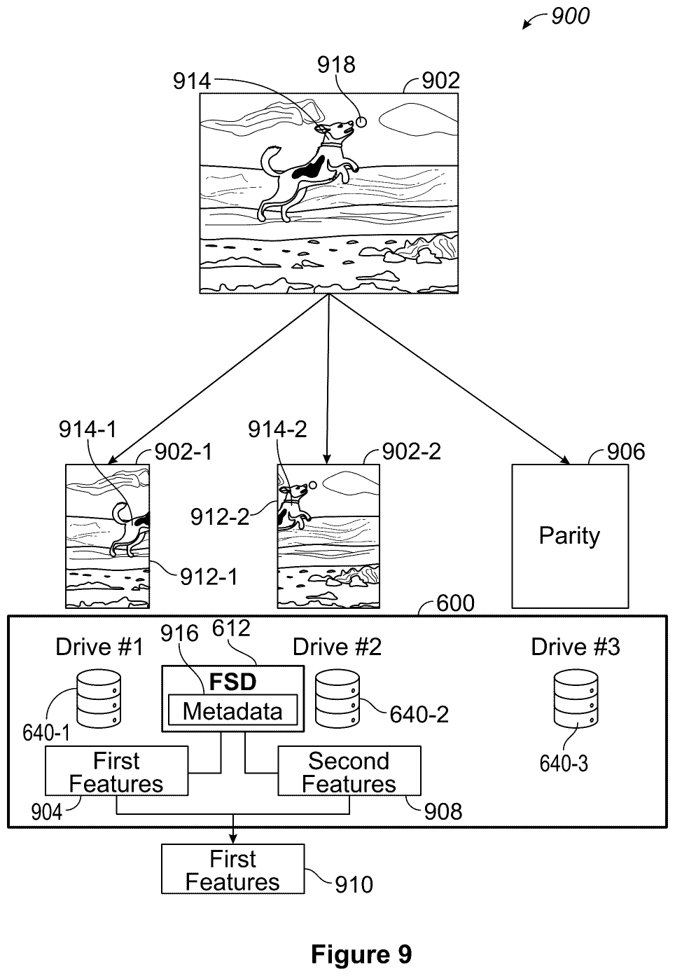

FIG. 7 is a diagram illustrating an example process 700 of managing data and four example system implementation schemes 740, in accordance with some embodiments. The process 700 is implemented by a computer system 300 that includes one or more servers 120, one or more client devices 240, and one or more smart devices 280, one or more storage devices 116, or a combination thereof. The computer system 300 has one or more processors 302 and memory 306 storing one or more programs for execution by the one or more processors 302. The computer system 300 obtains a first data block 702 and generates a set of one or more first features 704 of the first data block 702. The computer system 300 also obtains a second data block 706, independently of obtaining the first data block 702, and generates a set of one or more second features 708 of the second data block 706. The computer system associates the first data block 702 with the second data block 706. More specifically, in some embodiments, the computer device 300 determines that both the first data block 702 and the second block 706 belong to a file 710. In accordance with an association of the first data block 702 with the second data block 706, the computer device 300 generates one or more third features 712 of the file 710 based on the set of first features 704 and the set of second features 708. In an example, the file 710 includes an image (e.g., image 902 in FIG. 9) including two distinct and different image fragments, and the first data block 702 and the second data block 706 correspond to the two image fragments, respectively.

In some embodiments, the computer system 300 determines that the set of first features 704 and the set of second features 708 satisfy a data association criterion 714. In accordance with a determination that the set of first features 704 and the set of second features 708 satisfy the data association criterion 714, the first data block 702 is associated with the second data block 706. In some situations, the data association criterion 714 is satisfied, when a subset of the first features 704 and a subset of the second features 708 are substantially similar (e.g., have a similarity level that is greater than a threshold similarity level). For example, the subset of the first features 704 and the subset of the second features 708 correspond to average brightness levels of two distinct image fragments of the same image, and are substantially similar to each other. In another example, the subset of the first features 704 and the subset of the second features 708 correspond to two sets of pixel values of two edges of two image fragments, and match each other such that the two edges of two image fragments can be stitched together.

In some embodiments, the one or more third features 712 include at least one feature that is distinct from any feature of the set of first features 704 and the set of second features 708. Further, in some situations, the at least one feature corresponds to a feature event or an object. For example, the feature event or the object cannot be detected in each individual image fragment of an image, and is identified in a complete image, e.g., by combining the features 704 and 708 determined for the individual image fragments. As such, in some embodiments, the third feature(s) 712 are not detected in individual data blocks 702 and 706 of the file 710, and can be identified in the file 710, e.g., by combining the features 704 and 708 determined for the data blocks 702 and 706.

Additionally or alternatively, in some embodiments, the one or more third features 712 of the file 710 preserve a subset or all of the features 704 and 708 of the individual data blocks 702 and 706 of the file 710. The one or more third features 712 of the file include a subset of first features 704, a subset of second features 708, or both.

In some embodiments, the first data block 702 and the second data block 706 are processed to generate the features 704 and 708 by the same device (e.g., a memory device 640 storing both of the data blocks 702 and 706, a camera 110 capturing two images corresponding to the data blocks 702 and 706, a server 120 obtaining the data blocks 702 and 706 from the same smart device 280 or client device 240). In other words, the computer system 300 includes a first electronic device. The first electronic device determines the first data block 702 and the second data block 706 are available, e.g., independently of each other. In accordance with a determination that the first data block 702 is available, the first electronic device determines the set of first features 704 based on the first data block 702 independently of an availability of the second data block 706 and the set of second features 708 at the first electronic device. In accordance with a determination that the second data block 706 is available, the first electronic device determines the set of second features 708 based on the second data block 706, independently of an availability of the first data block 702 and the set of first features 704 at the first electronic device.

In some embodiments, the first data block 702 and the second data block 706 are processed to generate the features 705 and 708 by a memory device 640. The memory device includes an FSD 612 storing metadata of the file 710 identifying the first data block 702 and the second data block 706, and the first data block 702 and the second data block 706 are associated with each other based on the metadata stored in the FSD 612.

In some embodiments, the first data block 702 and the second data block 706 are processed to generate the features 704 and 708 by two distinct devices (e.g., two memory devices 640 storing the data blocks 702 and 706 separately; two cameras 110 capturing two images corresponding to the data blocks 702 and 706 separately, two servers 120 obtaining the data blocks 702 and 706 from the same device or two different devices). In other words, in some embodiments (e.g., associated with system implementation schemes 740-1 and 740-2), the computer system 300 includes a first electronic device 716A and a second electronic device 716B. The first electronic device 716A determines the first data block 702 is available. In accordance with a determination that the first data block 716A is available, the set of first features 704 are determined from the first data block 702, independently of an availability of the second data block 706 and the set of second features 708 at the second electronic device 716B. The second electronic device 716B determines the second data block 706 is available. In accordance with a determination that the second data block 706 is available, the set of second features 708 are determined from the second data block 706, independently of an availability of the first data block 702 and the set of first features 704 at the first electronic device 716A.

Further, in some embodiments (e.g., associated with the scheme 740-1), the first electronic device 716A provides the set of first features 704 to the second electronic device 716B, and the second electronic device 716B associates the first data block 702 with the second data block 706 and generates the one or one third features 712. Alternatively, in some embodiments (e.g., associated with the scheme 740-2), the first electronic device 716A (e.g., a camera 110, a storage device 116) provides the set of first features 704 to a third electronic device 716C (e.g., a server 120), so does the second electronic device 716B (e.g., a distinct camera 110, a distinct storage device 116) provide the set of second features 708 to the third electronic device 716C. The third electronic device 716C associates the first data block 702 with the second data block 706 and generates the one or one third features 712.

In some embodiments (e.g., associated with the scheme 740-3), the computer system 300 includes a first memory device 640A (e.g., an SSD) and a second memory device 640B (e.g., a distinct SSD), and each of the first memory device 640A and the second memory device 640B has a respective data processor 660 for extracting respective features 704 or 708 from a respective data block 702 or 706 stored on the respective memory device 640A or 640B. The first data block 702 is stored and the set of first features 704 are extracted in the first memory device 640A, and the second data block 706 is stored and the set of second features 708 are extracted in the second memory device 640B. Further, in some implementations, each of the first memory device 640A and the second memory device 640B includes a respective SSD. In some implementations, each of the first memory device 640A and the second memory device 640B includes a respective NAND flash memory.

Additionally, in some embodiments, each memory device 640A or 240B determines whether a respective one of the first data block 702 and the second data block 706 includes respective user data (also called data stripe) or integrity data (e.g., parity data associated with the user data), e.g., based on metadata of the data block 702 or 706 extracted from an FSD 612. In accordance with the first data block 702 include first user data, the first memory device 640A generates the set of first features 704. In accordance with the second data block 706 include second user data, the second memory device 640B generates the set of second features 708. Under some circumstances, data are stored in the first memory device 640A and the second memory device 640B according to a RAID scheme, and each of the data blocks 702 and 706 include user data or integrity data, but not both.

In some embodiments (e.g., associated with the scheme 740-3), the first memory device 640A provides the set of first features 704 to the second memory device 640B. The second memory device 640B associates the first data block 702 with the second data block 706 and generates the one or one third features 712. Alternatively, in some embodiments (e.g., associated with the scheme 740-4), the first memory device 640A provides the set of first features 704 to a host device 620 (e.g., a server 120), and the second memory device 640B provides the set of second features 708 to the host device 620, which further associates the first data block 702 with the second data block 706 and generates the one or one third features 712. In an example, the memory device 640A and 640B are two storage devices 116, and the host device 620 is a server 120 coupled to the two storage devices 116.

In some embodiments, the file 710 is an image. The first memory device 640A determines whether the first data block 702 includes at least part of the image. In some embodiments, the first memory device 640A may apply an image data block model to process the first data block 702 based on machine learning and determine whether the first data block 702 includes at least part of the image. For example, when the first data block 702 is an image fragment, the block 702 should include areas having similar colors, while non-image integrity data blocks do not have such characteristics. The image data block model is trained to determine whether the first data block 702 has such areas having similar colors. Alternatively, the first memory device 640A may extract metadata of the first data block 702, e.g., from an FSD 612. The FSD 612 may store locations of different data blocks of the same file 710 in the memory system 600 and link these locations to each other because they are associated with the same file 710.

In some embodiments, the computer system 300 applies a feature extraction model 720 (e.g., model 720A) to process the first data block 702 for extracting the set of first features 704. The computer system 300 further applies the feature extraction model 720 (e.g., model 720B) to the second data block 706 for extracting the set of second features 708. Compared with the data blocks 702 and 706, the features 704 and 708 have smaller data sizes and would be communicated in the computer system 300 associated with the smart work environment 100 at faster rates, while consuming less communication bandwidths, which could be limited and critical to performance of the computer system 300. More importantly, different fragments of a complete file 710 (e.g., an image) can be processed separately without being consolidated on a certain device of the computer system 300, thereby conserving the limited communication resources from transferring the data blocks 702 and 706 that may have relatively large sizes.

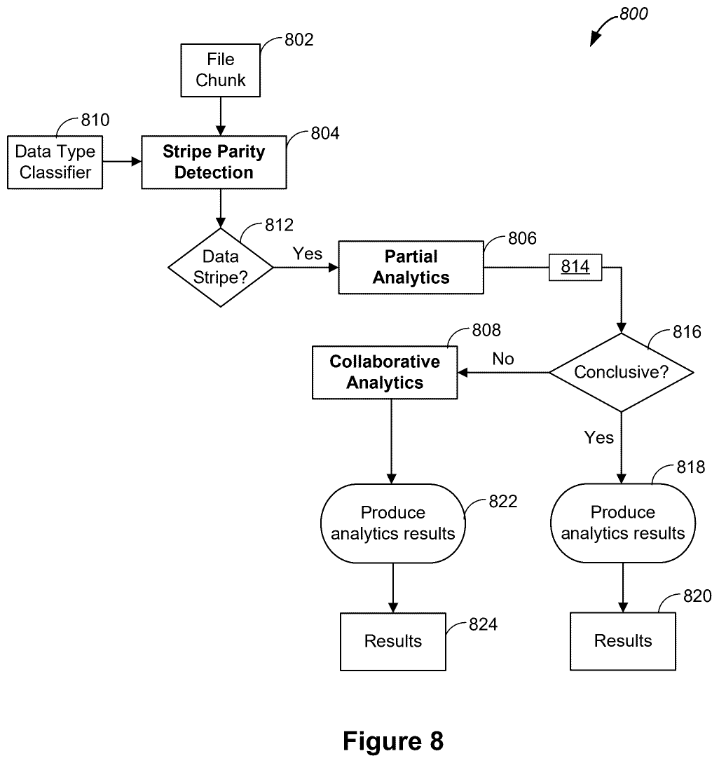

FIG. 8 is a flow diagram of an example process 800 for processing a file chunk 802 (e.g., a data block 702 or 706 of a file 710 in FIG. 7) at a memory system 600, in accordance with some embodiments. The process 800 is implemented by a memory system 600 that includes one or more storage devices (e.g., memory device 640). The memory system 600 has one or more processors 302 and memory 306 storing one or more programs for execution by the one or more processors 302. In some embodiment, the memory system 600 includes a stripe parity detection module 804, a partial analytics module 806, and a collaborative analytics module 808. The stripe parity detection module 804 receives the file chunk 802 and determines whether the file chunk 802 is a data stripe (e.g., user data) or a parity (e.g., integrity data associated with user data), e.g., using a machine learning based data type classifier 810. The data type classifier 810 may be trained, e.g., by a server 120. In some situations, the stripe parity detection module 804 receives the file chunk 802 explicitly from an operating system or a RAID controller, and determines (operation 812) whether the file chunk 802 includes user data (also called data strip) or integrity data (e.g., parity data). For example, the file chunk 802 is determined to correspond to an image having pixels of identical or substantially similar colors, particularly at boundaries of the image. Conversely, in some embodiments, the file chunk 802 corresponds to parity data and does not appear as consistent as the image, because the boundaries are combined with non-boundary data from the other data stripes.

In some embodiments, the partial analytics module 806 analyzes the file chunk 802 that is confirmed to contain partial data of a corresponding file 710 by the stripe parity detection module 804. For example, the partial analytics module 806 extracts first features 814 from the file chunk 802. The memory system 600 determines (operation 816) whether an output (e.g., the first features 814) provided by the partial analytics module 806 is conclusive. In some embodiments, in accordance with a determination that the output provided by the module 806 is conclusive, the partial analytics module 806 outputs (operation 818), as analysis result 820, the output generated based on the partial file data by the module 806. Alternatively, in some embodiments, in accordance with a determination that the output provided by the module 806 is not conclusive, the partial analytics module 806 generates an intermediate analysis result, and a request is sent to the collaborative analytics module 808 to orchestrate analysis on a full set of file data (e.g., the complete file 710). The collaborative analytics module 808 may collect and consolidate features determined based on different file chunks and them, e.g., to generate (operation 822) analytics results 824 associated with the complete file 710. In some embodiments, the partial analytics module 806 and/or the collaborative analytics module 808 are applied jointly for object detection on an image. The modules 806 and 808 identify things of interest in an image, and potentially feed information of the things of interest into an additional model or use case such as scene understanding.

In some embodiments, when results (e.g., first features 704) provided by the partial analytics module 806 are not complete, the collaborative analytics module 808 collaborates with other devices (e.g., another memory device 640, a client device 240, a smart device 280) to produce analytics results 820 of the entire file 710. For example, other data stripes may be retrieved from other memory device(s) 640 and processed to extract related features. The features extracted from different data stripes (e.g., located at the same device or distributed across different devices) may be orchestrated to enable analysis of the full file 710.

FIG. 9 is a flow diagram of a process 900 of processing an image 902 at least partially in a memory system 600 in a distributed manner, in accordance with some embodiments. The memory system 600 includes a plurality of memory devices 640 (e.g., SSDs). Referring to FIG. 9, the memory system 600 at least includes a first memory device 640-1, a second memory device 640-2, and a third memory device 640-3. The image 902 is partitioned to two image fragments 902-1 and 920-2, which are stored in the memory devices 640-1 and 640-2, respectively. In some embodiments, each of the two image fragments 902-1 and 920-2 corresponds to a respective data block 702 or 706 (also called a data stripe 702 or 706) stored in a respective memory device 640-1 or 640-2. In some embodiments, when each of the two image fragments 902-1 and 902-2 is stored in the memory system 600, the memory system 600 generates integrity data 906 based on the respective data block associated with the respective image fragment 902-1 or 902-2, and stores the integrity data 906 in the third memory device 640-3.

In some embodiments, the first memory device 640-1 obtains the first image fragment 902-1 and generates a set of one or more first features 904 of the first image fragment 902-1. The second memory device 640-2 obtains the second image fragment 902-2 and generates a set of one or more second features 908 of the second image fragment 902-2. The memory device 640-1, 640-2, or 640-3 or a distinct computer device (e.g., a server 120 or a distinct memory device not shown in FIG. 9) obtains both the first features 904 and the second features 908, and associates the first image fragment 902-1 with the second image fragment 902-2 (e.g., determines that the first image fragment 902-1 and the second image fragment 902-2 belong to the same image 902). In accordance with an association of the first image fragment 902-1 with the second image fragment 902-2, one or more third features 910 are generated based on the set of first features 904 and the set of second features 908. In some implementations, during the process 900, the image fragments 902-1 and 902-2 are processed locally by their respective memory devices 640 (specifically, a data processor 660 of each memory device 640), and do not need to be communicated among different memory devices 640. Memory input/output bandwidths can be preserved to facilitate efficient memory access operations, when features associated with the image fragments 902-1 and 902-2 (not the fragments themselves) are communicated among different memory devices 640.

In some embodiments, the set of first features 904 and the set of second features 908 satisfy a data association criterion 714 (e.g., in FIG. 7). The first image fragment 902-1 is associated with the second image fragment 902-2 in accordance with a determination that the set of first features 904 and the set of second features 908 satisfy the data association criterion 714. Further, in some embodiments, a subset of first features 904 corresponds to a first edge 912-1 of a first region of the image 902, and a subset of second features 908 corresponds to a second edge 912-2 of a second region of the image 902. The first region is immediately adjacent to the second region on the image 902. In accordance with the data association criterion 714, the subset of first features 904 and the subset of second features 908 match, and are associated with, each other. For example, referring to FIG. 9, the first edge 912-1 and the second edge 912-2 include pixels corresponding to sky, cloud, sea, dog, and beach, and therefore, match each other. Pixel values of the edges 912-1 and 912-2 are compared to determine whether the corresponding image fragments 902-1 and 902-2 match each other.

In some embodiments, the first image fragment 902-1 corresponds to a first region of the image 902, and the second image fragment 902-2 corresponds to a second region of the image 902, The first region is distinct from the second region. In some embodiments, an object 914 of the image 902 includes a first portion 914-1 located in the first region and a second portion 914-2 located in the second region. The first region of the image 902 corresponds to a subset of first features 904, and the second fragment corresponds to a subset of second features 908. When the first features 904 and the second features 908 are consolidated and processed to generate the third features 910, at least one third feature 910 corresponds to the object 914 or an action of the object 914. For example, referring to FIG. 9, two portions of a dog are located in two image regions corresponding to the image fragments 902-1 and 902-2, respectively, while a tennis ball is entirely located in the image fragment 902-2. The at least one third feature 910 indicates that the dog is identified or that the dog jumps up to catch a ball. The at least one third feature 910 may not be determined from either one of the image fragments 902-1 and 902-2, i.e., the dog and its action may not be identified based on either image fragment 902-1 or 902-2. Additionally, one of the third features 910 includes a second feature 908 associated with the tennis ball.

In some embodiments, the computer system 300 includes an FSD 612 (e.g., in an SSD) storing metadata 916 of the file 710 identifying the first image fragment 902-1 and the second image fragment 902-2, which are stored in two separate memory locations (e.g., distinct channels 604 in FIG. 6). The first image fragment 902-1 and the second image fragment 902-2 are associated with each other based on the metadata 916 stored in the FSD 612. Examples of the metadata 916 include, but are not limited to, a time stamp, a file identification, a file name, a block header, and a camera identification. Further, in some embodiments, the computer system 300 stores a plurality of image fragments of different images including the image 902. The second image fragment 902-2 matching the first image fragment 902-1 is selected from the plurality of image fragments based on the metadata 916 of the files.

In some embodiments, a data stripe may contain an object 914 entirely (e.g., tennis ball 918 in the image fragment 902-2) or partially (e.g., the dog in the image fragment 902-2). If an object 914 or an item of interest for the use case is fully contained in a data stripe, associated features may be stored as the metadata (e.g. tennis ball) for the image fragment. However, if an object 914 got divided across multiple data stripes, then each memory device 640 may detect that it contains a partial object. In some situations, a memory device 240 labels the object 914. For example, the memory device 640-2 detects a head of a dog in the image fragment 902-2, and determines that the second portion 914-2 of the object 914 corresponds to the dog. Conversely, in some situations, ambiguity may exist, after the memory devices 640-1 and 640-2 segment their respective portions of a dog independently. Each memory device 640-1 or 640-2 may need to identify one or more memory devices 640 that may have other segmented portions of the dog. In some embodiments, each of a plurality of memory devices 640 hands off features of its respective portion of the dog (e.g., inconclusive segmentation) to the next memory device 640. For example, the first features 904 associated with the first portion 914-1 of the dog may be handed off from the first memory device 640-1 to the second memory device 640-2 or other memory devices 640, thereby identify the second image fragment 902-2 or any other image fragment that matches the first image fragment 902-2 containing the first portion 914-1 of the dog.

In some implementations, the image 902 is stored across a memory system 600 including the memory devices 640-1, 640-2, and 640-3 according to a RAID scheme, in which a user data block may be stored in duplication and an integrity data block may be stored separately from an associated user data block. The memory device 640-1 obtains the first image fragment 902-1 and detects a dog's body, thereby determining the first image fragment 902-1 as a data stripe (e.g., not integrity data). Conversely, the memory device 640-3 obtains data stored on itself and fails to identify any object, thereby determining that the data stored on the memory device 640-3 are integrity data 906 (e.g., not a data stripe including an image fragment). In some embodiments, each memory device 640 obtains a data block and applies a stripe parity model to determine whether the data block is a data stripe or integrity data based on machine learning. The stripe parity model is trained based on training data before it is deployed to each memory device 640 to differentiate between the data stripe and integrity data.

In some embodiments, in accordance with a determination that the image fragment 902-1 is a data stripe, a partial analytics module 806 of the memory device 640-1 processes the image fragment 902-1 and fails to determine an action of the dog, e.g., when a confidence score fails to reach a confidence threshold. The first features 904 generated by the memory device 640-1 include a location of the half dog in the first image fragment 902-1, and are used to determine whether another portion of the dog may exist in a corresponding location of a different image fragment. After obtaining the first features 904 of the first image fragment 902-1, the memory device 640-1 may send a message to other memory devices 640, and the message includes the first features 904, e.g., a location of the first portion 914-1 of the dog measured along the first edge 912-1 of the first image fragment 902-1. In some embodiments, the memory device 640-3 determines that it includes integrity data 906 and does not answer the message from the memory device 640-1. The memory device 640-2 returns a message to the first memory device 640-1 indicating that the second image fragment 902-2 includes an object identified.

In some embodiments, the memory devices 640-1 and 640-2 identify compute resources to join the two image fragments 902-1 and 902-2 for further analysis. If one of the memory devices 640-1 and 640-2 has sufficient compute resources, the one of the memory devices 640-1 and 640-2 sends a message to the other one of the memory devices 640-1 and 640-2 to indicate its availability. If neither one of the memory devices 640-1 and 640-2 has sufficient compute resources, then the memory devices 640-1 and 640-2 send a request to the rest of remaining memory device(s) 640 or the server(s) 120. In an example, further analysis may be offloaded to another memory device 640 (e.g., memory device 640-3) that is underutilized.

In some embodiments, the memory devices 640-1 and 640-2 send features 904 and 908 to the memory device 640-3. The memory device 640-3 joins the respective image fragments 902-1 and 902-2 based on the features 904 and 908, and generates third features 910, e.g., identifying that the object is a dog (more specifically, a dog in mid-air catching a tennis ball). In some situations, the third features 910 are further provided to the memory devices 640-1 and 640-2, allowing the memory devices 640-1 and 640-2 to label their respective image fragments with the third feature(s) 910. In an example, the memory device 640-1 and 640-2 store the image fragments 902-1 and 902-2, respectively, and may determine that the image fragments 902-1 and 902-2 include respective portions of a dog,. Based on the third features 910, the memory device 640-3 determines the respective portions of the dog match and form a complete dog having an action of “catching a tennis ball.” Additional context information of “catching a ball in mid-air” is not determined from each individual image fragment 902-1 or 902-2, and is determined (e.g., by the third memory device 640-3) based on the features 904 and 908.

FIG. 10A depicts an example smart work environment 1000 associated with a vehicle assembly line, in accordance with some implementations. The vehicle assembly line is created in a structure 140 (e.g., in FIG. 1), and managed in the smart work environment 1000. Robotics plays a pivotal role in automating the assembly line, ensuring precision, speed, and consistency. Robots 1002 are tasked with various functions, including welding, painting, assembling components, and installing parts like engines and doors. For example, robotic arms, equipped with precise control systems, handle delicate tasks such as screwing and fastening, while larger machines manage heavy lifting and body construction. Smart devices 280 such as cameras 110 are integrated to enhance a vehicle assembling process. Cameras 110 inspect the quality of welds, paint, and alignment, while other sensors monitor factors like temperature, pressure, and vibrations to detect abnormalities. The cameras 110 may be fixed on the structure 140 or disposed on the robots 1002 (e.g., on a robotic arm).

Additionally, in some embodiments, the smart devices 280 applied on the vehicle assembly line further include one or more of: a proximity sensor, a vision sensor, a pressure sensor, a temperature sensor, a torque sensor, a laser distance sensor, and a vibration sensor. The proximity sensor detects the presence or absence of objects, such as vehicle parts, without physical contact, ensuring components are correctly positioned before robotic arms engage in assembly tasks. The vision sensor may be integrated with cameras, and captures images to inspect the quality of welds, paint jobs, or part alignment. The pressure sensor is used to monitor and control the application of force during tasks like clamping, pressing, or fastening, ensuring that each component is assembled with the correct tension. The temperature sensor monitors the temperature during processes like welding or painting, ensuring optimal conditions for material bonding and paint curing. The torque sensors is used to measure the torque applied when bolts or screws are tightened. The laser distance sensor measures the distance between parts or verify alignment during the assembly process, making sure components fit together precisely. The vibration sensor is placed on machinery and robotic arms for detecting irregular vibrations that might indicate wear or malfunction, allowing for predictive maintenance before a breakdown occurs. Each of these sensors may record respective work data 160 and process the work data 160 locally to identify respective features, which may provide additional new features when consolidated.

The smart devices 280 (including the robots 1002), client devices 240, and servers 120 communicate in real-time in the smart work environment 1000, enabling predictive maintenance and adjustments, improving efficiency, and reducing the likelihood of defects or downtime on the vehicle assembly line. More specifically, in some embodiments, individual data blocks are collected by individual smart devices 280, processed in a distributed manner and adaptively based on local resources, and further consolidated to provide features that may not be available in the individual data blocks.

FIG. 10B depicts an example smart work environment 1050 associated with an electronics manufacturing facility, in accordance with some implementations. Manufacturing of integrated circuits (ICs) in the electronic manufacturing facility is a complex and precise process involving multiple stages. It begins with the creation of silicon wafers, which are the base for IC fabrication. These wafers undergo photolithography, where patterns of circuits are etched onto them using UV light and specialized chemicals. Deposition and ion implantation processes add various layers of materials, forming transistors, capacitors, and other electronic components. Robots and high-precision machines handle these delicate processes to ensure accuracy at the microscopic level. Smart devices 280 like cameras and sensors are integrated throughout the facility to enhance quality control. Vision sensors inspect each wafer for defects or misalignments during photolithography, while temperature and pressure sensors monitor the conditions during deposition and etching. Additionally, particle sensors in clean rooms detect airborne contaminants that could affect the delicate wafers. These smart systems provide real-time data, ensuring that each step of IC production is performed under optimal conditions, leading to high-quality, reliable circuits.

The smart devices 280, client devices 240, and servers 120 communicate in real-time in the smart work environment 1050, enabling predictive maintenance and adjustments, improving efficiency, and reducing the likelihood of defects or downtime on the vehicle assembly line. More specifically, in some embodiments, individual data blocks are collected by individual sensor devices 280, processed in a distributed manner and adaptively based on local resources, and further consolidated to provide features that may not be available in the individual data blocks. For example, a first data block (e.g., block 702 in FIG. 7) corresponds to a first image that is captured by a first camera 110-1 and associated with a first field of view, and the second data block (e.g., block 706 in FIG. 7) corresponds to a second image that is captured by a second camera 110-2 and associated with a second field of view. The first field of view is distinct from the second field of view. The camera 110-1 or a server 120 generates a set of one or more first features of the first data block. The camera 110-2, the same server, or a distinct server 120 generates a set of one or more second features 708 of the second data block 706. In accordance with an association of the first data block 702 with the second data block 706, one or more third features are generated based on the set of first features and the set of second features. In some situations, the one or more third features may include a new feature that does not exist in the first and second features, thereby providing supplemental information to understand the electronics manufacturing facility.

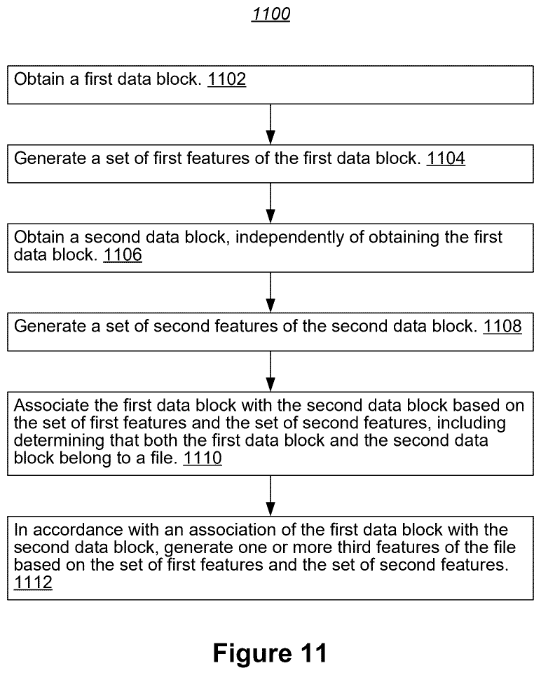

FIG. 11 is a flow diagram of an example data management method 1100, in accordance with some embodiments. For convenience, the method 1100 is described as being implemented by a computer system 300 (e.g., a server 120, a client device 240, a smart device 280, or a combination thereof). Method 1100 is, optionally, governed by instructions that are stored in a non-transitory computer readable storage medium and that are executed by one or more processors of the computer system. Each of the operations shown in FIG. 11 may correspond to instructions stored in a computer memory or non-transitory computer readable storage medium (e.g., memory 306 in FIG. 3). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1100 may be combined and/or the order of some operations may be changed.

A computer system 300 obtains (operation 1102) a first data block 702 and generates (operation 1104) a set of first features 704 of the first data block 702. The computer system 300 obtains (operation 1106) a second data block 706, independently of obtaining the first data block 702, and generates (operation 1108) a set of second features 708 of the second data block 706. The computer system 300 associates (operation 1110) the first data block 702 with the second data block 706, e.g., determines that both the first data block 702 and the second data block 706 belong to a file 710. In accordance with an association of the first data block 702 with the second data block 706, the computer system 300 generates (operation 1112) one or more third features 712 of the file 710 based on the set of first features 704 and the set of second features 708.

In some embodiments, the computer device 300 determines that the set of first features 704 and the set of second features 708 satisfy a data association criterion 714, wherein the first data block 702 is associated with the second data block 706 in accordance with a determination that the set of first features 704 and the set of second features 708 satisfy the data association criterion 714. Further, in some embodiments (FIG. 9), a subset of first features 704 corresponds to a first edge 912-1 of a first region of an image 902, and a subset of second features 708 corresponds to a second edge 912-2 of a second region of the image 902. The first region is immediately adjacent to the second region on the image. In accordance with the data association criterion 714, the subset of first features 704 and the subset of second features 708 match each other.

In some embodiments, the one or more third features 712 include at least one feature that is distinct from any feature of the set of first features 704 and the set of second features 708. Further, in some embodiments, the at least one feature corresponds to a feature event or an object.

In some embodiments, the one or more third features 712 further include a subset of first features 704 or a subset of second features 708.

In some embodiments, the computer system includes a first electronic device. The first electronic device determines that the first data block 702 and the second data block 706 are available independently of each other. In accordance with a determination that the first data block 702 is available, the set of first features 704 are determined from the first data block 702, independently of an availability of the second data block 706 and the set of second features 708 at the first electronic device. In accordance with a determination that the second data block 706 is available, the set of second features 708 are determined from the second data block 706, independently of an availability of the first data block 702 and the set of first features 704 at the first electronic device.

In some embodiments, the computer system includes a first electronic device 716A and a second electronic device 716B. The first electronic device 716A determines that the first data block 702 is available. In accordance with a determination that the first data block 702 is available, the set of first features 704 are determined from the first data block 702, independently of an availability of the second data block 706 and the set of second features 708 at the second electronic device 716B. The second electronic device 716B determines that the second data block 706 is available. In accordance with a determination that the second data block 706 is available, the set of second features 708 are determined from the second data block 706, independently of an availability of the first data block 702 and the set of first features 704 at the first electronic device 716A. Further, in some embodiments, the first electronic device 716A provides the set of first features 704 to the second electronic device 716B. At the second electronic device 716B, the first data block 702 is associated with the second data block 706, and the one or one third features 712 are generated. In some embodiments, the first electronic device 716A provides the set of first features 704 to a third electronic device 716C, and the second electronic device 716B provides the set of second features 708 to the third electronic device 716C. At the third electronic device 716C, the first data block 702 is associated with the second data block 706, and the one or one third features 712 are generated.

In some embodiments, the computer system includes a first memory device 640A and a second memory device 640B, and each of the first memory device 640A and the second memory device 640B has a respective data processor 660 (FIG. 6) for extracting respective features from a respective data block stored on the respective memory device locally. The first data block 702 is stored and the set of first features 704 are extracted in the first memory device 640A. The second data block 706 is stored and the set of second features 708 are extracted in the second memory device 640B. Further, in some embodiments, each of the first memory device 640A and the second memory device 640B includes a respective solid-state drive (SSD). The computer system determines whether each of the first data block 702 and the second data block 706 includes respective user data (e.g., corresponding to a data stripe) or integrity data. In some embodiments, the first memory device 640A provides the set of first features 704 to the second memory device 640B. At the second memory device 640B, the first data block 702 is associated with the second data block 706, and the one or one third features 712 are generated. Alternatively, in some embodiments, the first memory device 640A provides the set of first features 704 to a host device 620, and the second memory device 640B provides the set of second features 708 to the host device 620. At the host device 620, the first data block 702 is associated with the second data block 706, and the one or one third features 712 are generated.

In some embodiments, the computer system determines whether the first data block 702 includes at least part of an image 902 by applying an image data block model to process the first data block 702 or extracting metadata of the first data block 702.

In some embodiments (FIG. 9), the first data block 702 corresponds to a first region of an image 902, and the second data block 706 corresponds to a second region of the image 902. The first region is distinct from the second region. Further, in some embodiments, an object of the image 902 includes a first portion located in the first region and a second portion located in the second region. The first portion corresponds to a subset of first features 704, and the second portion corresponds to a subset of second features 708. At least one third feature corresponds to the object (e.g., the dog in FIG. 9) or an action of the object (e.g., a dog catching a tennis ball).

In some embodiments, the first data block 702 corresponds to a first image that is captured by a first camera (e.g., camera 110-1 in FIG. 10B) and associated with a first field of view, and the second data block 706 corresponds to a second image that is captured by a second camera (e.g., camera 110-2 in FIG. 10B) and associated with a second field of view, the first field of view distinct from the second field of view.

In some embodiments, the computer system 300 applies a feature extraction model 720 to the first data block 702 for extracting the set of first features 704 and applies the feature extraction model 720 to the second data block 706 for extracting the set of second features 708.

In some embodiments, the computer system includes a file system directory 612 storing metadata of the file 710 identifying the first data block 702 and the second data block 706, and the first data block 702 and the second data block 706 are associated with each other based on the metadata (e.g., metadata 916 in FIG. 9) stored in the file system directory 612. Further, in some embodiments, the computer system 300 selects the second data block 706 from a plurality of data blocks based on the metadata of the file 710.

It should be understood that the particular order in which the operations in FIG. 11 have been described are merely exemplary and are not intended to indicate that the described order is the only order in which the operations could be performed. One of ordinary skill in the art would recognize various ways to enhance speech quality. Additionally, it should be noted that details of other processes described above with respect to FIGS. 1-10B are also applicable in an analogous manner to method 1100 described above with respect to FIG. 11. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,”depending on the context.

It is also to be appreciated that while the terms user may be used to refer to the person or persons acting in the context of some particularly situations described herein, these references do not limit the scope of the present teachings with respect to the person or persons who are performing such actions. Importantly, while the identity of the person performing the action may be germane to a particular advantage provided by one or more of the implementations, such identity should not be construed in the descriptions that follow as necessarily limiting the scope of the present teachings to those particular individuals having those particular identities.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed.

Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method, comprising:
at a computer system having one or more processors and memory:
obtaining a first data block;
generating a set of first features of the first data block;
obtaining a second data block, independently of obtaining the first data block;
generating a set of second features of the second data block;
associating the first data block with the second data block, including determining that both the first data block and the second data block belong to a file; and
in accordance with an association of the first data block with the second data block, generating one or more third features of the file based on the set of first features and the set of second features.

2. The method of claim 1, further comprising determining that the set of first features and the set of second features satisfy a data association criterion, wherein the first data block is associated with the second data block in accordance with a determination that the set of first features and the set of second features satisfy the data association criterion.

3. The method of claim 2, wherein:
a subset of first features corresponds to a first edge of a first region of an image, and a subset of second features corresponds to a second edge of a second region of the image;
the first region is immediately adjacent to the second region on the image; and
in accordance with the data association criterion, the subset of first features and the subset of second features match each other.

4. The method of claim 1, wherein the one or more third features include at least one feature that is distinct from any feature of the set of first features and the set of second features, and the at least one feature corresponds to a feature event or an object.

5. The method of claim 1, wherein the one or more third features further include a subset of first features or a subset of second features.

6. The method of claim 1, wherein the computer system includes a first electronic device, the method further comprising:
determining, by the first electronic device, the first data block and the second data block are available independently of each other;
wherein in accordance with a determination that the first data block is available, the set of first features are determined from the first data block, independently of an availability of the second data block and the set of second features at the first electronic device;
wherein in accordance with a determination that the second data block is available, the set of second features are determined from the second data block, independently of an availability of the first data block and the set of first features at the first electronic device.

7. The method of claim 1, wherein the computer system includes a first electronic device and a second electronic device, the method further comprising:
determining, by the first electronic device, the first data block is available, wherein in accordance with a determination that the first data block is available, the set of first features are determined from the first data block, independently of an availability of the second data block and the set of second features at the second electronic device; and
determining, by the second electronic device, the second data block is available, wherein in accordance with a determination that the second data block is available, the set of second features are determined from the second data block, independently of an availability of the first data block and the set of first features at the first electronic device.

8. The method of claim 7, further comprising:
providing, by the first electronic device, the set of first features to the second electronic device, wherein at the second electronic device, the first data block is associated with the second data block, and the one or one third features are generated.

9. The method of claim 7, further comprising:
providing, by the first electronic device, the set of first features to a third electronic device; and
providing, by the second electronic device, the set of second features to the third electronic device, wherein at the third electronic device, the first data block is associated with the second data block, and the one or one third features are generated.

10. The method of claim 1, wherein the computer system includes a first memory device and a second memory device, and each of the first memory device and the second memory device has a respective data processor for extracting respective features from a respective data block stored on the respective memory device locally;
wherein the first data block is stored and the set of first features are extracted in the first memory device; and
wherein the second data block is stored and the set of second features are extracted in the second memory device.

11. The method of claim 10, wherein each of the first memory device and the second memory device includes a respective solid-state drive (SSD), the method further comprising:
determining whether each of the first data block and the second data block includes respective user data or integrity data; and
providing, by the first memory device, the set of first features to the second memory device, wherein at the second memory device, the first data block is associated with the second data block, and the one or one third features are generated.

12. The method of claim 10, further comprising:
providing, by the first memory device, the set of first features to a host device; and
providing, by the second memory device, the set of second features to the host device, wherein at the host device, the first data block is associated with the second data block, and the one or one third features are generated.

13. The method of claim 1, further comprising determining whether the first data block includes at least part of an image by implementing:
applying an image data block model to process the first data block; or
extracting metadata of the first data block.

14. The method of claim 1, wherein the first data block corresponds to a first region of an image, and the second data block corresponds to a second region of the image, and wherein the first region is distinct from the second region.

15. The method of claim 14, wherein:
an object of the image includes a first portion located in the first region and a second portion located in the second region;
the first portion corresponds to a subset of first features, and the second portion corresponds to a subset of second features; and
at least one third feature corresponds to the object or an action of the object.

16. The method of claim 1, wherein the first data block corresponds to a first image that is captured by a first camera and associated with a first field of view, and the second data block corresponds to a second image that is captured by a second camera and associated with a second field of view, the first field of view distinct from the second field of view.

17. The method of claim 1, further comprising:
applying a feature extraction model to the first data block for extracting the set of first features; and
applying the feature extraction model to the second data block for extracting the set of second features.

18. The method of claim 1, wherein the computer system includes a filesystem directory storing metadata of the file identifying the first data block and the second data block, and the first data block and the second data block are associated with each other based on the metadata stored in the filesystem directory, and wherein obtaining a second data block further comprises selecting the second data block from a plurality of data blocks based on the metadata of the file.

19. A computer system, comprising:
one or more processors; and
memory storing one or more programs for execution by the one or more processors, the one or more programs further comprising instructions for:
obtaining a first data block;
generating a set of first features of the first data block;
obtaining a second data block, independently of obtaining the first data block;
generating a set of second features of the second data block;
associating the first data block with the second data block, including determining that both the first data block and the second data block belong to a file; and
in accordance with an association of the first data block with the second data block, generating one or more third features of the file based on the set of first features and the set of second features.

20. A non-transitory computer-readable storage medium, storing one or more programs for execution by one or more processors, the one or more programs further comprising instructions for:
obtaining a first data block;
generating a set of first features of the first data block;
obtaining a second data block, independently of obtaining the first data block;
generating a set of second features of the second data block;
associating the first data block with the second data block, including determining that both the first data block and the second data block belong to a file; and
in accordance with an association of the first data block with the second data block, generating one or more third features of the file based on the set of first features and the set of second features.
